(19) United States
(12) Patent Application Publication
(10) Pub. No.: US 2025/0196164 A1
(43) Pub. Date: Jun. 19, 2025

(54) MULTIFUNCTIONAL SHOWER HEAD

(71) Applicant: PURITY (XIAMEN) TECHNOLOGY CO.LTD., Fujian (CN)

(72) Inventors: Shi Fa Huang, Fujian (CN); Ming Qiang Yan, Fujian (CN); Guo Zhong Wu, Fujian (CN)

(73) Assignee: PURITY (XIAMEN) TECHNOLOGY CO.LTD., Fujian (CN)

(21) Appl. No.: 18/748,029

(22) Filed: Jun. 19, 2024

(30) Foreign Application Priority Data
Dec. 14, 2023 (CN) 202323423874.1

(51) Int. Cl. B05B 1/18; B05B 1/16

(52) U.S. Cl. CPC B05B 1/18; B05B 1/1636

(57) ABSTRACT

A multifunctional shower head includes a water inlet base and a water outlet component. The water inlet base is provided with a water inlet channel, a plugging part and a water inlet through hole. A water outlet component is provided with a water chamber, a water outlet hole and at least two water inlet holes. When the water inlet through hole is arranged relative to one water inlet hole, this water inlet through hole is connected with the water inlet hole in a sealing manner, and the rest of water inlet holes are sealed and plugged by the plugging part. The multifunctional shower head can make the water inlet holes corresponding to each functional spray share the water outlet holes together, resulting that the water outlet area of various sprays can be effectively increased, and then the comfort of the sprays is improved.

### CROSS-REFERENCE TO RELATED APPLICATION

This application claims the priority benefit of China application serial no. 202323423874.1, filed on Dec. 14, 2023. The entirety of the above-mentioned patent application is hereby incorporated by reference herein and made a part of this specification.

### TECHNICAL FIELD

The present disclosure relates to the field of shower heads, in particular to a multifunctional shower head.

### BACKGROUND

The multifunctional shower head refers to a shower head that can output at least two types of sprays by switching waterways. In order to increase the effluent water force intensity and achieve the massage effect for the sprays, the existing shower head is designed with pulse sprays that can intermittently discharge water. Different kinds of water outlet holes are respectively used for the pulse sprays and common sprays, and each kind of water outlet hole respectively occupies a part of the surface cover. Then under the condition that the area of the surface cover and the spacing of the water outlet holes are fixed, the number of water outlet holes of various sprays is small, and the water outlet area is small, which can affect the comfort of the spray.

### SUMMARY OF INVENTION

The present disclosure provides a multifunctional shower head to at least solve the technical problem that how to increase the water outlet area of various sprays and improve the comfort of the spray.

To solve the technical problems, the present disclosure provides the following technical schemes.

A multifunctional shower head, includes:
a water inlet base, the water inlet base being provided with a water inlet channel, a plugging part and a water inlet through hole connected with the water inlet channel; and the plugging part and the water inlet through hole are located on the same circular trajectory;
a water outlet component, the water outlet component being rotatably connected with the water inlet base and being provided with a water chamber, a water outlet hole and at least two water inlet holes; the water inlet holes and the water outlet hole are respectively connected with the water chamber, and the rotating path of the water inlet holes are set relative to the circular trajectory;
wherein, when the water inlet through hole is arranged relative to one water inlet hole, the water inlet through hole is connected with this water inlet hole in a sealing manner, and the rest of water inlet holes are sealed and plugged by the plugging part.

In some embodiments, the water outlet component includes a first water sealing base, a second water sealing base and a water outlet jacket which are connected in sequence; the first water sealing base is rotatably connected with the water inlet base and is provided with a water inlet holes; the water diversion waterways are formed between the second water sealing base and the first water sealing base; the water diversion waterways are configured to connect the water inlet holes and the water chamber; the water outlet jacket is provided with a water outlet hole, and the water chamber is formed between the water outlet jacket and the second water sealing base.

In some embodiments, the water outlet component also includes a rotating support; the rotating support is rotatably in sleeve connection with the water inlet base and the outer side of the first water sealing base so that the water inlet base is rotatably connected with the first water sealing base.

In some embodiments, the water outlet component also includes a sealing gasket and an elastic member which are arranged inside the water inlet through hole and the plugging part; the sealing gasket is provided with an inner hole and is in sealing contacted with the inner side of the water inlet through hole; the elastic member is supported by the water inlet base to push the sealing gasket, so that the sealing gasket is in sealing contact with the first water sealing base; when the water inlet through hole is arranged relative to the water inlet hole, the water inlet through hole is connected with the inner hole of the sealing gasket in the water inlet hole in a sealing manner.

In some embodiments, when the water inlet through hole is arranged relative to one water inlet hole, the rest of water inlet holes are arranged relative to the plugging part.

In some embodiments, the second water sealing base is provided with an annular groove and water through holes; the water through holes can connect with the annular groove and the water chamber; and the annular groove is connected with one of the water diversion waterways; the multifunctional shower head also includes a guide van and a rotating van; the rotating van is rotatably arranged in the annular groove and is provided with a closed section and an open section; the closed section is configured to shield the water through hole, and the open section is configured to open the water passage hole; the guide van arranged at an opening of the annular groove and are provided with water guide holes; the water guide holes are configured to obliquely guide the water flow of the water diversion waterway into the annular groove, so that the rotating van rotates.

In some embodiments, the water outlet component also includes a branch waterway; the branch waterway is provided with a water inlet and a water outlet; the rotating path of the water inlet is arranged relative to the water inlet through hole; the water inlet and the water inlet through hole are sealed and connected with each other when the water inlet and the water inlet through hole are arranged relatively.

Compared with the prior art, the multifunctional shower head provided by the present disclosure has the following beneficial effects.

When the multifunctional shower head works, water flows in from the water inlet channel of the water inlet base, and flows through the water inlet through hole, then enter the water outlet component. The water outlet component can rotate relative to the water inlet base. When the water inlet through hole is arranged relative to one water inlet hole, the water inlet through hole is connected with the water inlet hole in a sealing manner, and the water can enter the water chamber through the water inlet hole, and finally the water can be ejected from the water outlet hole to output corresponding functions of sprays. In this process, the rest of the water inlet holes are connected with the plugging part in a sealing manner to prevent the water flow from escaping back to the water inlet holes corresponding to other functional sprays, so that the water flow can be used for intensively outputting the current functional sprays and ensuring the hydraulic output force of the sprays. It can be seen that the multifunctional shower head in this disclosure, connects the water inlet holes corresponding to various kinds of functional sprays with the water chamber at the same time, and the water outlet hole is shared. So that it is not necessary to use different water outlet holes to output different sprays like the traditional shower head, and the water outlet area of various sprays can be effectively increased, and then the comfort of the sprays is improved.

### BRIEF DESCRIPTION OF DRAWINGS

FIG. 1 is a space diagram of a multifunctional shower head in a section view in the embodiment.

FIG. 2 is an explosive view of a multifunctional shower head at a first viewing angle in the embodiment.

FIG. 3 is an explosive view of a multifunctional shower head at a second viewing angle in the embodiment.

### DESCRIPTION OF EMBODIMENTS

In the following, the technical schemes of the embodiment of the present disclosure is clearly and completely described in combination with the attached figures in the embodiment of the present disclosure.

In the existing multifunctional shower head, different water outlet holes are used for outputting different sprays, and the water outlet holes jointly occupy a part of the surface cover. Under the condition that the area of the surface cover and the spacing of the water outlet holes are fixed, the number of water outlet holes of various sprays is small, and the water outlet area is small, so as to affect the comfort of the spray.

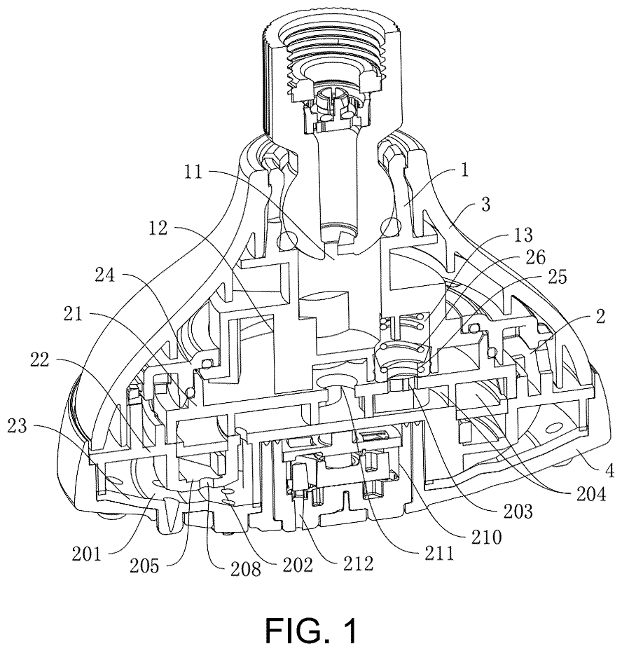

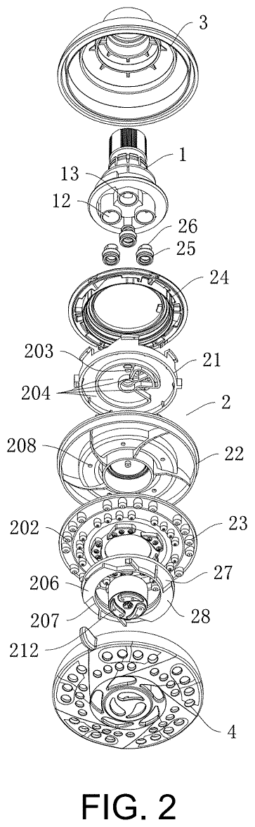

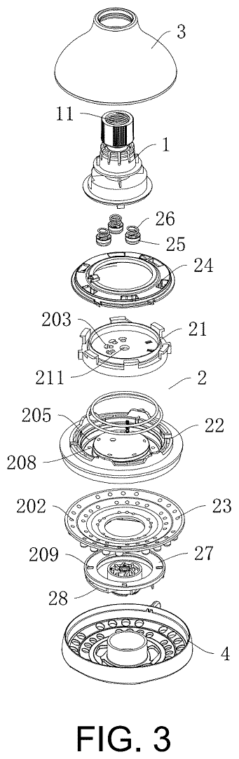

In order to solve the technical problems above, the embodiment provides a multifunctional shower head. Referring to FIG. 1 to FIG. 3, FIG. 1 is a space diagram of a multifunctional shower head in a section view state in the embodiment. FIG. 2 is an explosive view of a multifunctional shower head at a first viewing angle in the embodiment. FIG. 3 is an explosive view of a multifunctional shower head at a second viewing angle in the embodiment.

The multifunctional shower head in the embodiment includes a water inlet base 1 and a water outlet component 2.

The water inlet base 1 is provided with a water inlet channel 11, a plugging part 12 and a water inlet through hole 13 connected with the water inlet channel 11, and the plugging part 12 and the water inlet through hole 13 are located on the same circular trajectory.

The water inlet base 1 transports water flow to the water outlet component 2 through the water inlet channel 11 and the water inlet through hole 13, and the plugging part 12 is disconnected from the water inlet channel 11 and the water inlet through hole 13.

The water outlet component 2 is rotatably connected with water inlet base 1 and is provided with a water chamber 201, a water outlet hole 202 and at least two water inlet holes 203. The water inlet holes 203 and the water outlet hole 202 are respectively connected with the water chamber 201. The rotating path of the water inlet holes 203 and the circular trajectory are arranged relatively.

The water outlet component 2 guides the water in the water inlet through hole 13 to flow into the water chamber 201 through the water inlet holes 203, and the spray is formed through the water outlet hole 202. Wherein, the center of the rotating path of the water inlet holes 203 and the circular trajectory are both located on a rotating center line of the water outlet component 2. One of the water inlet holes 203 and the water inlet through hole 13 can be arranged relatively through the rotation of the water outlet component 2.

Wherein, when the water inlet through hole 13 is arranged relative to one water inlet hole 203, the water inlet through hole 13 is connected with this water inlet hole 203 in a sealing manner, and the rest of water inlet holes 203 are connected with the plugging part 12 in a sealing manner.

Understandably, the multifunctional shower head may also may include a shell 3 and a surface cover 4 for mounting the water inlet base 1 and the water outlet component 2. The water inlet base 1 is fixed relative to the shell 3. The shell 3 is rotatably connected to the surface cover 4, and the surface cover 4 is connected to the water outlet component 2. The user can control the water outlet component 2 to rotate relative to the water inlet base 1 by rotating the surface cover 4.

When the multifunctional shower head in the above technical scheme works, water flows in from the water inlet channel 11 of the water inlet base 1, and flows through the water inlet through hole 13, then entering the water outlet component 2. The water outlet component 2 can rotate relative to the water inlet base 1. When the water inlet through hole 13 is arranged relative to one water inlet hole 203, the water inlet through hole 13 is connected with the water inlet hole 203 in a sealing manner, and the water can enter the water chamber 201 through the water inlet hole 203, and finally the water can be ejected from the water outlet hole 202 to output sprays with corresponding functions. In this process, the rest of the water inlet holes 203 are connected with the plugging part 12 in a sealing manner, so that the water flow in the water chamber 201 can flow into the plugging part 12 through other water inlet holes 203. Then the water pressure inside the water inlet base 1 can be balanced, and the water flow can also be prevented from escaping back to the water inlet holes 203 corresponding to other functional sprays, so that the water flow can be used for intensively outputting the current functional sprays and ensuring the hydraulic output force of the sprays. It can be seen that the multifunctional shower head in the embodiment, connects the water inlet holes 203 corresponding to various kinds of functional sprays with the water chamber 201 at the same time, and the water outlet hole 202 is shared. So that it is not necessary to use different water outlet holes 202 to output different sprays like the traditional shower head, and the water outlet area of various sprays can be effectively increased, and then the comfort of the sprays is improved.

In one embodiment of the water outlet component 2 above, the water outlet component 2 includes a first water sealing base 21, a second water sealing base 22 and a water outlet jacket 23 which are connected in sequence, and the first water sealing base 21, the second water sealing base 22 and the water outlet jacket 23 can be connected by a buckle structure to realize synchronous rotation. The first water sealing base 21 is rotatably connected with the water inlet base 1 and is provided with a water inlet hole 203. The water diversion waterways 204 are formed between the second water sealing base 22 and the first water sealing base 21, and are configured to connect the water inlet holes 203 and the water chamber 201. The water outlet jacket 23 is provided with a water outlet hole 202. A water chamber 201 is formed between the water outlet jacket 23 and the second water sealing base 22. And the water outlet jacket 23 can be connected with the surface cover 4. When working, the water outlet jacket 23 can rotate through controlling the surface cover 4, and the second water sealing base 22 and the first water sealing base 21 are driven to rotate in turn, so that one of the water inlet holes 203 is connected with the water inlet through hole 13 in a sealing manner. Wherein, a plurality of water chambers 201 can be arranged and isolated from each other, and one water diversion waterway 204 can be respectively connected with each water chamber 201 through a plurality of water through holes.

In one embodiment that the first water sealing base 21 is rotatably connected with the water inlet base 1, the water outlet component 2 also includes a rotating support 24. The rotating support 24 is rotatably arranged in the shell 3 and is in sleeve connection with the water inlet base 1 and the outer side of the first water sealing base 21. And the sealing parts are arranged between the rotating support 24 and the water inlet base 1 and between the rotating support 24 and the first water sealing base 21, so that the water inlet base 1 can be rotatably connected with the first water sealing base 21.

In one embodiment that the water inlet through hole 13 is connected with the water inlet holes 203 in a sealing manner, the water outlet component 2 also includes a sealing gasket 25 and an elastic member 26 which are arranged in the water inlet through hole 13 and the plugging part 12. The sealing gasket 25 is provided with an inner hole and is in sealing contact with the inner side of the water inlet through hole 13. The elastic member 26 is supported by the water inlet base to push the sealing gasket 25, so that the gasket 25 is in sealing contact with the first water sealing base 21. When the water inlet through hole 13 is arranged relative to the water inlet holes 203, the water inlet through hole 13 is connected with the inner hole of the sealing gasket 25 within the water inlet holes 203 in a sealing manner. At the same time, since the water inlet through hole 13 and the plugging part 12 are both provided with elastic members 26, the elastic force can uniformly act on the water inlet base 1 and the first water diversion base, so that the stability of the structure is improved.

It can be understood that the water inlet through hole 13 and the water inlet holes 203 can also be sealed and connected by setting an annular elastic sealing part on the edge of the water inlet through hole 13. At this time, the elastic sealing part forms a sealed channel between the water inlet through hole 13 and the water inlet holes 203.

In order to further improve the stability of the structure, when the water inlet through hole 13 is arranged relative to one water inlet holes 203, the rest of water inlet holes 203 are arranged relative to the plugging part 12. The plugging part 12 can be a blind hole, and the interval between adjacent plugging parts 12 or between the plugging part 12 and the water inlet through hole 13 can be the same. At the same time, the depths and apertures of the plugging part 12 and the water inlet through hole 13 can also be the same. In this way, the elastic force and water pressure can act on the water inlet base 1 and the first water sealing base more evenly, so that the internal structure of the multifunctional shower head is stabler.

The above water diversion waterways 204 can be provided with components for forming various functional sprays, and an embodiment for forming pulsed sprays is disclosed as follows. The second water sealing base 22 is provided with an annular groove 205 and water through holes 208. The water through holes 208 can connect the annular groove 205 with the water chamber 201, and the annular groove 205 is connected with one water diversion channel 204. The multifunctional shower head also includes guide van 27 and rotating van 28. The guide van 27 and the rotating van 28 are used for forming pulsed water flow. The rotating van 28 is rotatably arranged in the annular groove 205, and is provided with a closed section 206 and an open section 207. The closed section 206 is configured to shield the water through holes 208, and the open section 207 is configured to open the water passage holes 208. The guide van 27 is arranged at an opening of the annular groove 205, and are provided with water guide holes 209. The water guide holes 209 is configured to obliquely guide the water flow of the water diversion waterways 204 into the annular groove 205, so that the rotating van 28 rotates. In this embodiment, the water flow of one of the water diversion waterways 204 enters the annular groove 205 through the water guide holes 209 of the guide blade 27, then the rotating van 28 is pushed to rotate. When the closed section 206 of the rotating van 28 is relative to the water through hole 208, the water flow cannot enter the water chamber 201 from the water through hole 208. When the open section 207 of the rotating van 28 is relative to the water through hole 208, the water flow passes through the open section 207 and enters the water chamber 201 from the water through hole 208. Thus, water is intermittently supplied for the water chamber 201, and the pulsed sprays with intermittent effluent water can be formed at the water outlet hole 202.

Understandably, other water diversion waterways 204 may be provided with components corresponding to other functional sprays, or may not be provided with components to form a common continuous effluent spray.

In this embodiment, the water outlet component 2 also includes a branch waterway 210. The branch waterway 210 is provided with a water inlet 211 and a water outlet 212. The water inlet 211 is arranged on the first water sealing base 21, and the rotating path of the water inlet 211 is relative to the water inlet through hole 13. The water outlet 212 can be arranged on the surface cover 4. The water inlet 211 and the water inlet through hole 13 are sealed and connected with each other when the water inlet 211 and the water inlet through hole 13 are relative to each other. The water flow from the water inlet through hole 13 can enter the branch waterway 210 through the water inlet 211, and then sprays out from the water outlet 212 to form sprays with other functions. Wherein, the branch waterway 210 can be internally provided with components for forming sprays with corresponding functions.

Although the embodiments of the present disclosure have already been illustrated and described, various changes, modifications, replacements and transformations can be made by those skilled in the art under the condition of without departing from the principle and the spirit of the present disclosure, and thus the scope of the present disclosure should be restricted by claims and equivalents thereof.

What is claimed is:

1. A multifunctional shower head, comprising:
a water inlet base, provided with a water inlet channel, a plugging part and a water inlet through hole connected with the water inlet channel, wherein the plugging part and the water inlet through hole are located on a circular trajectory;
a water outlet component, rotatably connected with the water inlet base and being provided with a water chamber, a water outlet hole and at least two water inlet holes, wherein the water inlet holes and the water outlet hole are respectively connected with the water chamber, and a rotating path of the water inlet holes are set corresponding to the circular trajectory,
wherein when the water inlet through hole is arranged corresponding to one of the water inlet holes, the water inlet through hole is connected with the one of the water inlet holes in a sealing manner, and the rest of the water inlet holes are sealed and plugged by the plugging part.

2. The multifunctional shower head according to claim 1, wherein the water outlet component comprises a first water sealing base, a second water sealing base and a water outlet jacket which are connected in sequence;
the first water sealing base is rotatably connected with the water inlet base and is provided with the water inlet holes;
water diversion waterways are formed between the second water sealing base and the first water sealing base; the water diversion waterways are configured to connect with the water inlet holes and the water chamber;
the water outlet jacket is provided with the water outlet hole, and the water chamber is formed between the water outlet jacket and the second water sealing base.

3. The multifunctional shower head according to claim 2, wherein the water outlet component also comprises a rotating support, the rotating support is rotatably in sleeve connection with the water inlet base and an outer side of the first water sealing base so that the water inlet base is rotatably connected with the first water sealing base.

4. The multifunctional shower head according to claim 2, wherein the water outlet component also comprises a sealing gasket and an elastic member which are arranged inside the water inlet through hole and the plugging part,
the sealing gasket is provided with an inner hole and is in sealing contacted with an inner side of the water inlet through hole, the elastic member is supported by the water inlet base to push the sealing gasket, so that the sealing gasket is in sealing contact with the first water sealing base;
when the water inlet through hole is arranged corresponding to the one of the water inlet holes, the water inlet through hole is connected with the sealing gasket inside the one of the water inlet holes in a sealing manner.

5. The multifunctional shower head according to claim 1, wherein when the water inlet through hole is arranged corresponding to the one of the water inlet holes, the rest of water inlet holes are arranged corresponding to the plugging part.

6. The multifunctional shower head according to claim 4, wherein when the water inlet through hole is arranged corresponding to the one of the water inlet holes, the rest of water inlet holes are arranged corresponding to the plugging part.

7. The multifunctional shower according to claim 2, wherein the second water sealing base is provided with an annular groove and water through holes; the water through holes connect with the annular groove and the water chamber; and the annular groove is connected with one of the water diversion waterways;
the multifunctional shower head also comprises a guide van and a rotating van; the rotating van is rotatably arranged in the annular groove and is provided with a closed section and an open section, the closed section is configured to shield the water through hole, and the open section is configured to open the water through hole;
the guide van is arranged at an opening of the annular groove and are provided with water guide holes, and the water guide holes are configured to obliquely guide a water flow of the water diversion waterway into the annular groove, so that the rotating van rotates.

8. The multifunctional shower head according to claim 1, wherein the water outlet component also comprises a branch waterway, the branch waterway is provided with a water inlet and a water outlet; a rotating path of the water inlet is arranged corresponding to the water inlet through hole; and the water inlet and the water inlet through hole are sealed and connected with each other when the water inlet and the water inlet through hole are arranged correspondingly.
